(19) United States
(12) Patent Application Publication
(10) Pub. No.: US 2010/0020280 A1
(43) Pub. Date: Jan. 28, 2010

(54) METHOD FOR ALIGNING LIQUID CRYSTALS

(75) Inventor: Jeffery C. Hill, Westminster, CO (US)

Correspondence Address: POLSINELLI SHUGHART PC, 700 West 47th Street, Suite 1000, KANSAS CITY, MO, 64112, US

(73) Assignee: Pathogen Dection Systems, Inc. d/b/a Pathogen Systems, Inc., Louisville, CO (US)

(21) Appl. No.: 12/373,051

(22) PCT Filed: Mar. 13, 2008
(86) PCT No.: PCT/US08/56908

§ 371 Date: Jan. 8, 2009

Related U.S. Application Data
(60) Provisional application No. 60/895,227, filed on Mar. 16, 2007.

(51) Int. Cl. G02F 1/1337

(52) U.S. Cl. 349/126; 349/191

(57) ABSTRACT

A method of aligning liquid crystals in a cell includes the steps of optimizing the concentration of the liquid crystal in a carrier medium, transforming the liquid crystal into its isotropic phase; heating the cell to a temperature which is slightly lower than the temperature of the liquid crystal, filling the cell with the liquid crystal, rapidly cooling the filled cell to transform the liquid crystal into the nematic phase and rewarming the cell to a temperature approximately at the phase line separating the nematic phase from the mixed nematic nematic-isotropic phase. An improved alignment surface for forming the cell comprises an uncoated, rubbed surface to drive uniform alignment of the liquid crystals.

### CROSS REFERENCE TO RELATED APPLICATIONS

This application claims priority to U.S. Provisional Application No. 60/895,227, filed Mar. 16, 2007, and to U.S. Provisional Application No. 60/940,294, filed May 25, 2007 which both are incorporated herein by reference.

### FIELD OF THE INVENTION

The present invention relates generally to the alignment of liquid crystals. More specifically, the present invention relates to the alignment of salt-based and lyotropic liquid crystals in a cell which may be used in a system for detecting ligands, including pathogens and other toxic substances.

### BACKGROUND OF THE INVENTION

Recent efforts to develop systems for detecting bio-hazards such as pathogenic agents, microbes or toxic substances in drinking water supplies, food products or blood samples, have lead to new detection methodologies and devices which make use of the physical properties of liquid crystals to indicate the presence of a pathogenic agent in a liquid test specimen. Typically, such systems employ various immunological techniques on a molecular level to coat microspheres with known antibodies which attach to a pathogenic agent creating an aggregate in a manner such that the alignment of the liquid crystals in the liquid crystal matrix is disturbed. The disturbance in the alignment creates a detectable signal which, by way of example, could be polarized light, indicating the presence of a ligand.

Devices and methods for detection of liquids are disclosed in U.S. Pat. No. 6,171,802, issued Jan. 9, 2001 to Woolverton, et al., and U.S. Pat. No. 7,160,736, issued Jan. 9, 2007 to Niehaus, et al. Such detection devices may be adapted for use in the field so that they may be carried to site locations where test samples may be extracted directly from bodies of water such as lakes, reservoirs and rivers, by way of example, and tested on-site. Such testing devices may employ cartridges or test cells containing the liquid crystal matrix and the various pathogenic antibodies. The test specimen, the liquid crystal and the antibody-coated microspheres are injected into the cartridge which is inserted into the testing device for testing the sample. Subsequently, the cartridge is discarded or recycled.

A key element of the overall process involves charging the cartridges with the liquid crystal and thereafter aligning the liquid crystal prior to sample testing. The alignment times may consume on the order of 100 minutes or longer using presently known techniques. It is clear, therefore, that known alignment methodologies are overly time consuming, labor intensive and not conducive to high-speed testing cycles such might be encountered in epidemic or bio-terrorism situations where a relatively large number of test samples may be required to be taken, processed and analyzed in a very short time frame.

Two primary factors contributing to an improvement in alignment time involve optimization of the liquid crystal concentration in the carrier medium and optimizing the liquid crystal temperature profile at key points during the testing cycle. U.S. Patent Application Publication No. 2005/0079486 A1 published by Abbott, et al., Apr. 14, 2005, discloses a device and method for detecting a ligand which includes preparing an affinity substrate for capturing a ligand and transferring the ligand to a detection surface for detecting the ligand with a liquid crystal. This publication discloses the step of heating the test samples for extended periods of up to 18 hours or longer to effect alignment of the liquid crystal. However, the processes disclosed therein are not suitable for use in the field and are too time consuming for practical application in crisis situations.

U.S. Pat. No. 5,742,369, issued Apr. 21, 1998 to Mihara, et al., discloses a method of aligning liquid crystals sandwiched between a pair of substrates, each connected to an electrode, by applying an alternating electric field between the substrates under periodically changing temperature conditions. Again, however, the methodology of the '329 patent is not conducive to field application and does not attain the desired rapid alignment times indicated above.

A third critical factor in attaining liquid crystal alignment in a cell is the pre-charging processing applied to the substrates forming the cell prior to its assembly and filling with the liquid crystal.

Typically, the alignment technique is based upon a unidirectional treatment of the substrates that form the liquid crystal cell. One such technique is disclosed in U.S. Pat. No. 5,596,434, issued Jan. 21, 1997 to Walba, et al. and entitled “Self-Assembled Monolayers for Liquid Crystal Alignment.” The '434 patent discloses substrates which are coated with a polymer layer which is mechanically rubbed. The direction of rubbing sets the direction of orientation of the liquid crystal.

Another alignment technique is disclosed in U.S. Pat. No. 6,673,398, issued Jan. 6, 2004 to Schneider, et al., which discloses alignment of lyotropic chromatic liquid crystals by employing a method based upon alternate layer-to-layer absorption of polyions and dyes from aqueous solutions that have liquid crystalline structures. The technique of the '398 patent involves the alignment of multilayered stacks of liquid crystal films which find application in various optical devices such as polarizers, optical filters, and the like. However, it can be seen that such prior art alignment techniques involve the use of precise and complex manufacturing techniques and the application of very thin films of costly polymer materials to cell substrates, which, due to their temperature-sensitive physical properties, must be stored at low temperatures with limited shelf lives.

Accordingly, a need exists for a method of rapidly aligning the liquid crystal matrices used in systems designed for the detection of pathogens, toxins and other forms of bio-hazardous materials. A need also exists for a relatively low cost liquid crystal cell substrate material and method for achieving liquid crystal alignment within the cell which can be employed in high-volume manufacturing operations to produce the recyclable or discardable cartridges used in the field in systems designed for the detection of pathogens. The liquid crystal cell structure disclosed herein provides a relatively inexpensive cell having excellent liquid crystal alignment properties which may be stored at approximately room temperature and deployed in the field without requiring special storage or handling techniques. The methodology disclosed herein to align lyotropic and salt-based liquid crystals reduces the functional alignment time from approximately one hundred (100) minutes to well under ten (10) minutes.

### BRIEF DESCRIPTION OF THE FIGURES

FIG. 1 is a graph of the viscosity of two concentrations of a liquid crystal suspension as a function of temperature;

FIGS. 2-6 are the liquid crystal alignment curves as a function of temperature for various concentrations of liquid crystal;

FIG. 7 is the liquid crystal phase diagram for sodium cromolyn;

FIG. 8 is a photomicrograph of fill-related anomalies present in a liquid crystal cell; and

FIG. 9 is a graph of an optimized time-temperature profile for a liquid crystal cell filling and aligning cycle;

FIG. 10 is an image taken through cross polarizers of an uncoated glass substrate material rubbed with 1200 MP emory cloth according to an embodiment.

FIG. 11 is an image taken through cross polarizers of an uncoated glass substrate material rubbed with a paper towel according to an embodiment;

FIG. 12 is an image taken through cross polarizers of unaligned liquid crystal on the surface of an unrubbed, uncoated glass substrate material; and

FIG. 13 is an image of minute grooves formed in the surface of an uncoated glass substrate material by rubbing.

### DESCRIPTION OF THE INVENTION

Before proceeding with the detailed description, it should be noted that the present teaching is by way of example, not by limitation. The concepts presented herein are not limited to use or application with one specific method of liquid crystal alignment or related system.

Thus, although the instrumentalities described herein are for the convenience of illustration and explanation, shown and described with respect to exemplary embodiments, the principles disclosed herein may be applied to other types and applications of liquid crystals without departing from the scope of the present invention.

As set forth hereinabove, two primary factors contributing to improvement of liquid crystal alignment time involve optimization of the liquid crystal concentration in the carrier medium, by way of example, water, and optimizing the liquid crystal temperature profile at key points during the testing cycle. A series of step temperature function tests were developed to identify the preferred concentration levels of liquid crystal in a liquid crystal suspension. For testing purposes, a sodium cromolyn solution in water was selected; however, other salt-based and/or lyotropic liquid crystals and suspension media other than water may be used without departing from the scope and content of the present invention.

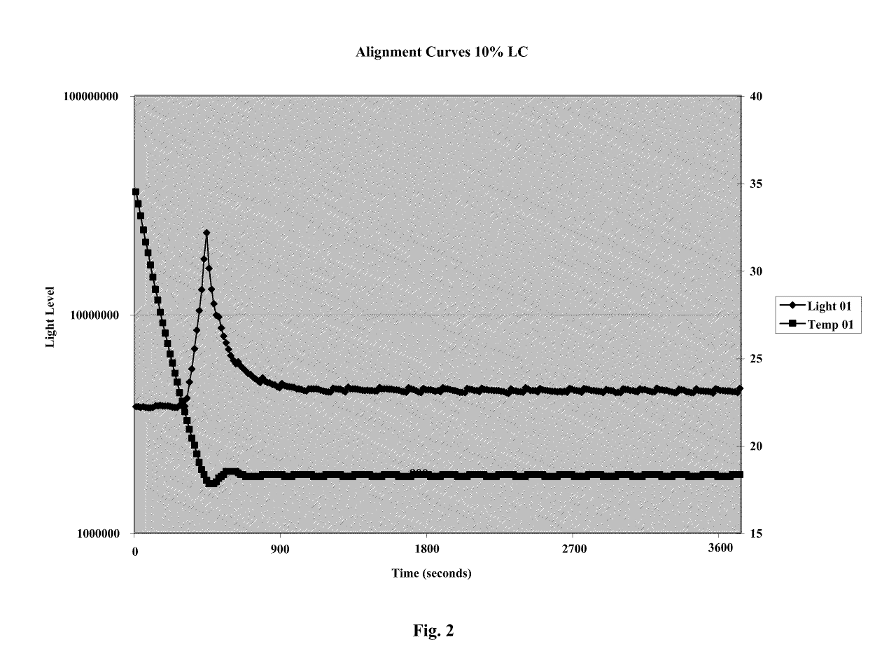

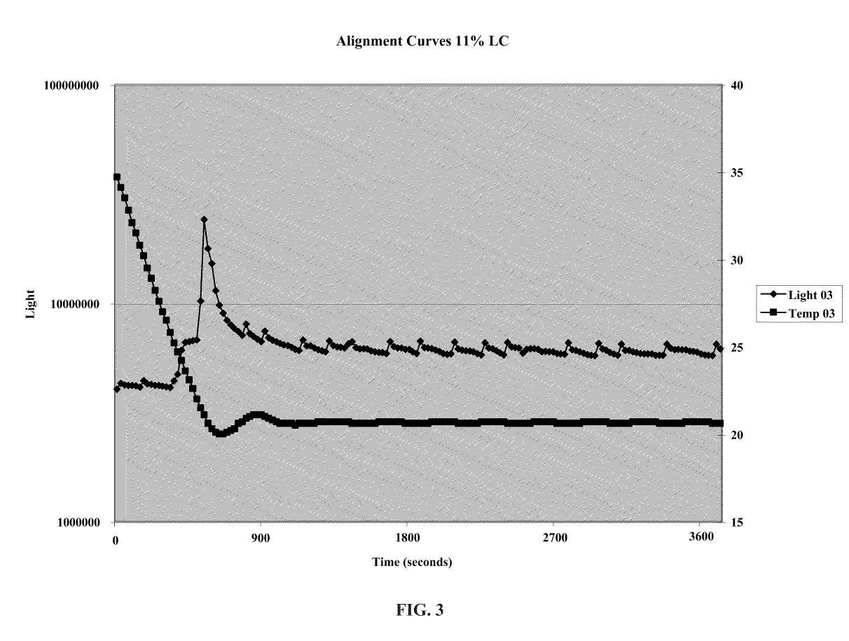

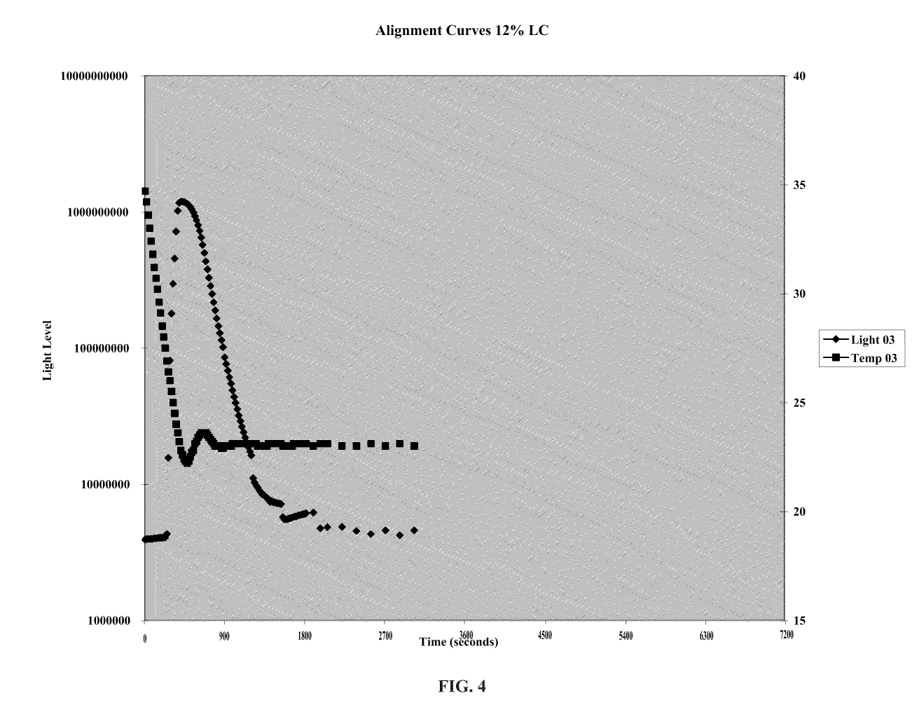

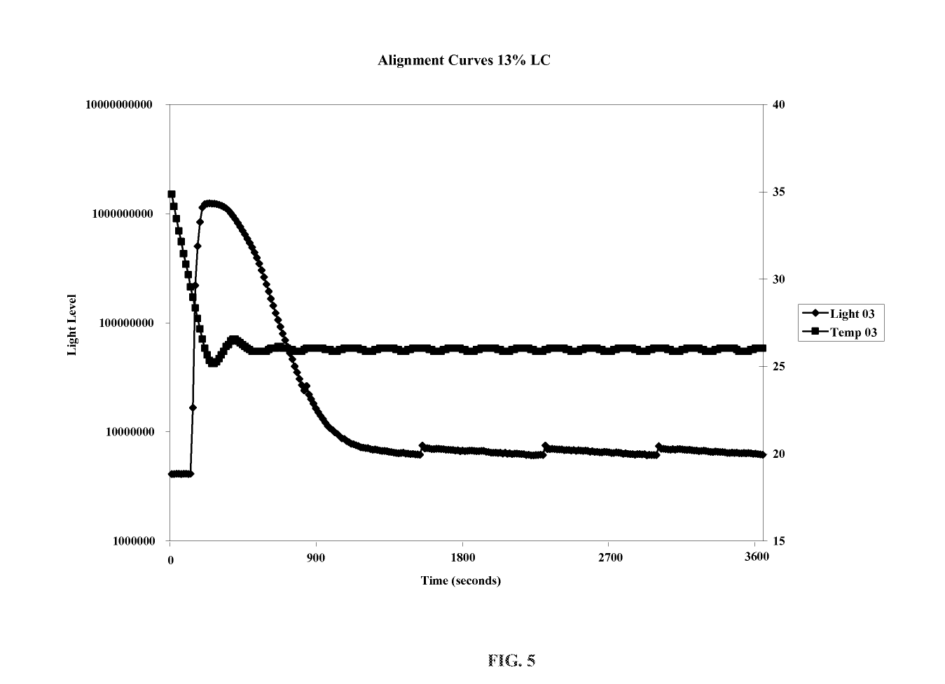

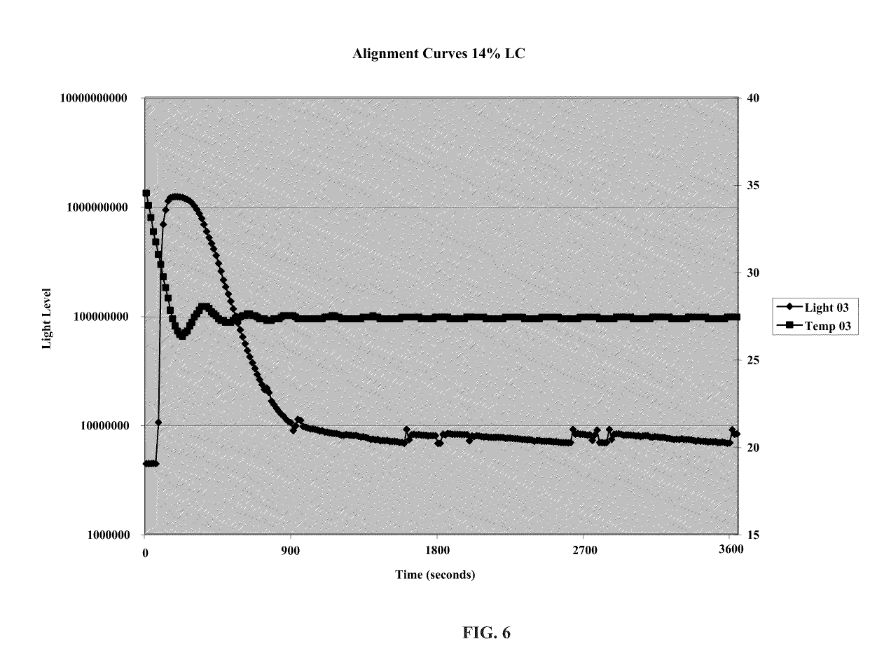

The liquid crystal concentrations were tested in concentration percentage increments of 1% at temperatures ranging from approximately 15° C. to approximately 40° C., and the alignment time was measured as a function of light transmission through the liquid crystal. FIGS. 2-6 display the results of these tests, which indicate that an 11% solution of sodium cromolyn in water yields the best combination of alignment time while still being suitable for use in the detection of ligands. (FIG. 3) It will be appreciated that these results are shown for purposes of illustration only, and that other compositions, suspensions and as yet unexplored system variables may render other concentrations more favorable without departing from the scope of the present invention.

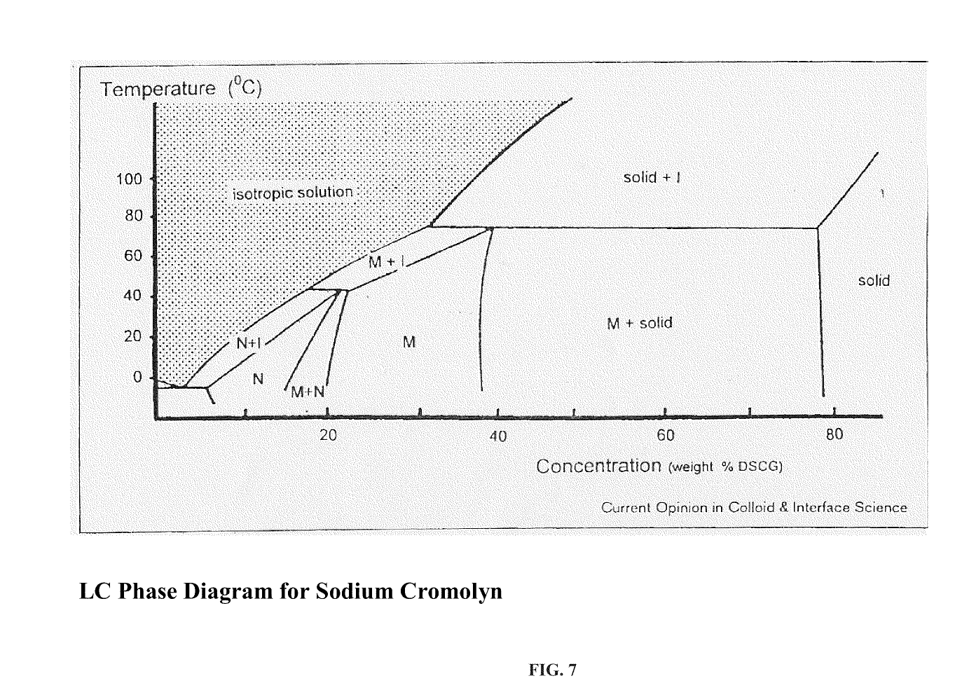

Optimizing the alignment temperature curve for a given liquid crystal concentration is a more involved process. The “no memory” alignment times of various liquid crystal concentrations under a variety of temperature curves were tested. “No memory,” as the term is used herein means an alignment of the liquid crystal which occurs when the liquid crystal is thoroughly mixed in the selected suspension medium with no residual effects of prior disturbances to its structure. Experimental data demonstrated that a substantial reduction in alignment time may be achieved by lowering the temperature of the cell containing liquid crystal at any prescribed concentration level well into the N (nematic) phase, then holding the cell temperature as close as possible to the boundary of the N to N+1 (nematic+isotropic) mixed phase as shown in FIG. 7.

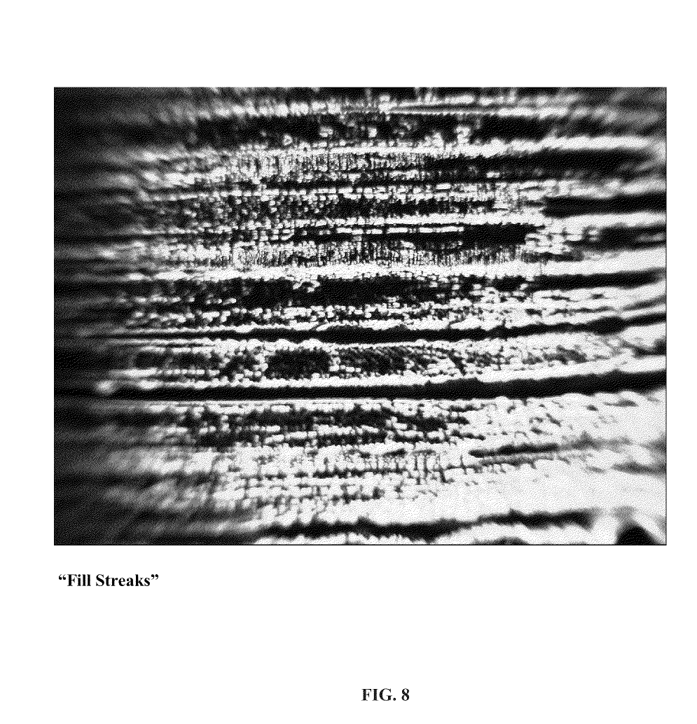

Once the liquid crystal concentration and “no memory” alignment curves had been optimized as shown in FIGS. 2-6, cells or cartridges formed by two substantially parallel alignment surfaces or substrates in the form of uncoated rubbed glass slides were prepared, as described in greater detail below, and cartridge charging tests were run using prototype field testing equipment. Initial fill tests using elevated slide and liquid crystal temperatures (40° C.), caused “fill streaks” and other fill related anomalies shown in FIG. 8. Various combinations of liquid crystal and slide temperatures were tested until it was discovered that an elevated liquid crystal temperature (about 40° C. to ensure that the liquid crystal is in the isotropic phase) in combination with a cooler slide temperature (30° C.) resulted in virtually no fill related anomalies. Other differentials may also be used without departing from the scope of the present invention; however, degradation of any biological component such as ligands, pathogens or antibodies, by way of example, limits temperatures to about 40° C. for the liquid crystalibiological mixture. It is believed that the water vapor from the warm liquid crystal may be pre-wetting the polyimide film applied to coated slides ahead of the introduction of the actual liquid crystal solution, thereby reducing the fill anomalies. Similar tests performed on uncoated slides where only the glass surface was rubbed in accordance with the present invention yielded similar results.

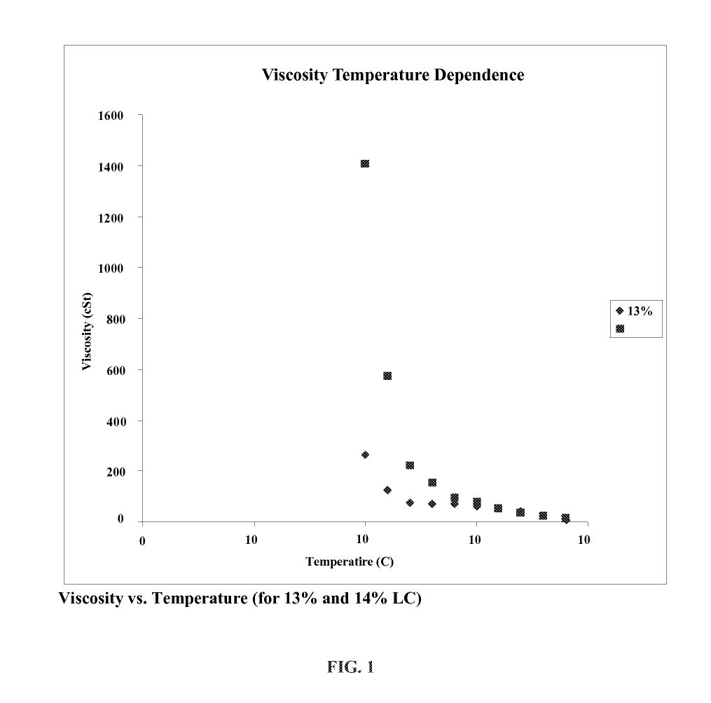

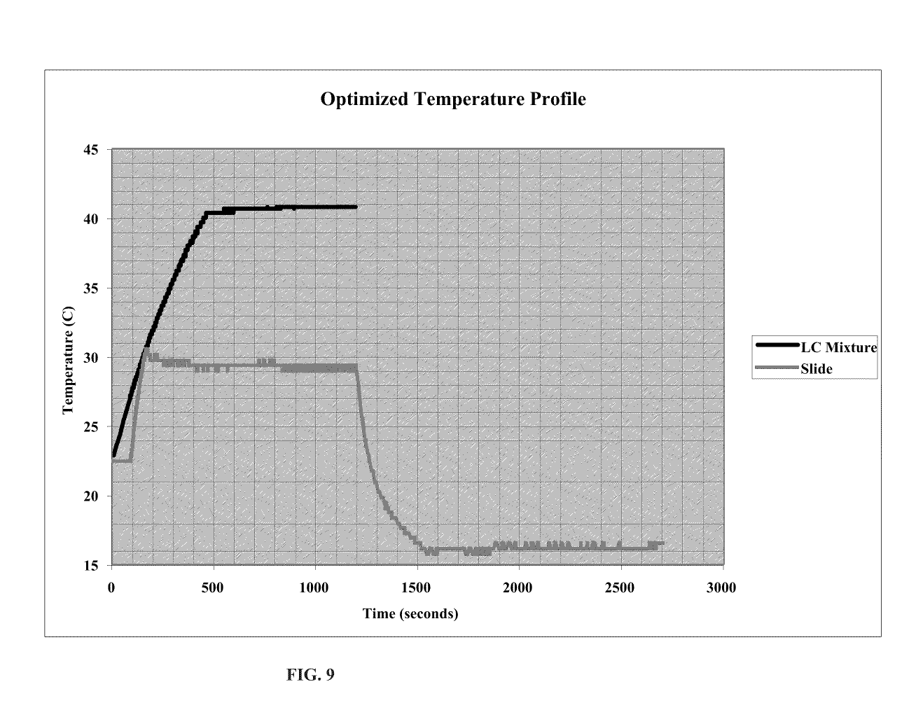

As a result, the preferred temperature profile and step sequence for an 11% sodium cromolyn solution involves heating the liquid crystal to a temperature of 40° C. during mixing while the slide is brought to 30° C. The cell is then filled. The filled cell is then cooled to 15.8° C. to raise the viscosity of the liquid crystal and thicken the fluid substantially so as to decrease the surface tension differential between the short chain and the long chain liquid crystals in solution to prevent the formation of micelles, or, small bubbles (see FIG. 1 for viscosity curve). Thereafter, the cell is gradually warmed to 16.6° C. (FIG. 9) to decrease the solution viscosity to facilitate rapid alignment.

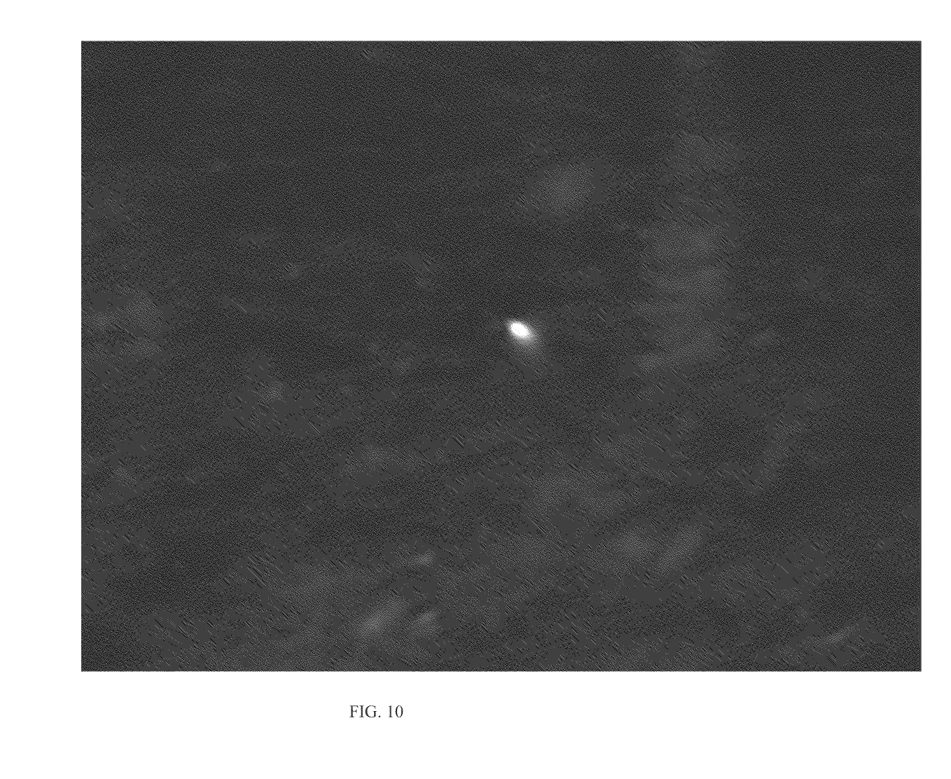

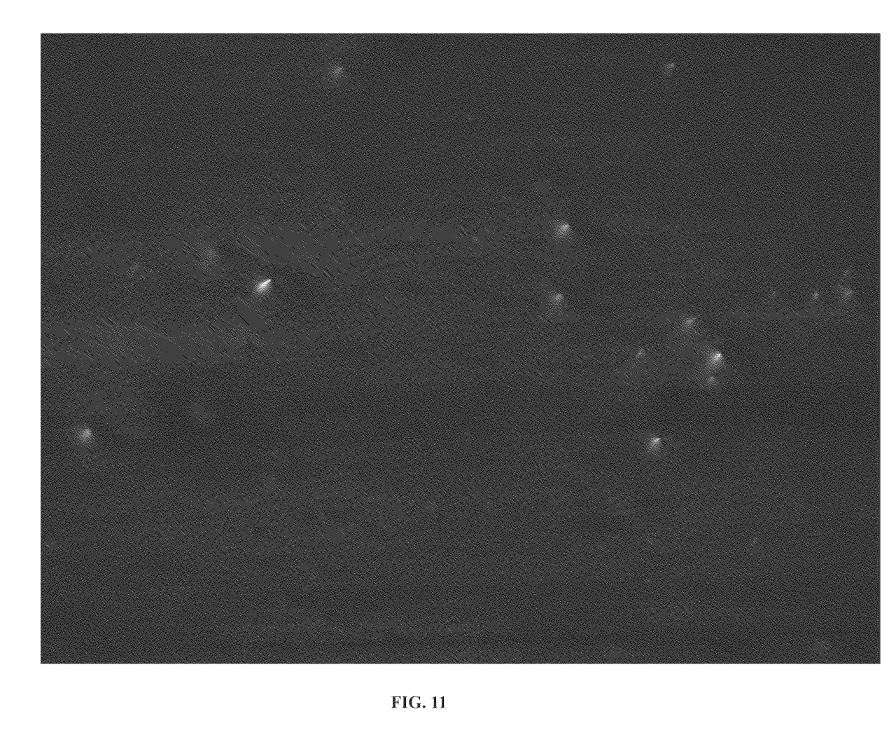

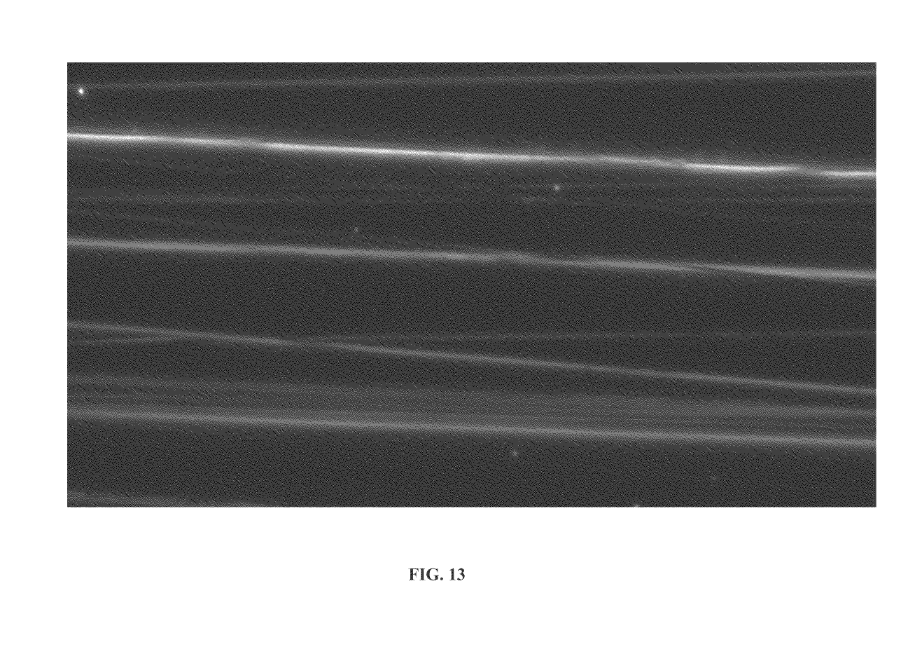

Addressing the third factor associated with liquid crystal alignment in a cell, namely preparation of the alignment substrates or, in this case, glass slides or panels which form the cell walls, based upon the premise that alignment of the liquid crystal within the cell may not be the result of the molecular chain structure of a thin polymer film deposited on the cell substrate material, as taught by the prior art, but rather, may be caused by minute grooves (FIG. 13) formed during the rubbing process, experiments were conducted using uncoated glass surfaces which were rubbed using various rubbing media. The substrate materials used for purposes of the test consisted of standard glass microscope slides which were rubbed in a direction parallel with the longitudinal axis of the slide. However, in addition to uncoated glass, alignment surfaces may also include thin-film metallized coatings, by way of example, gold or indium tin oxide (ITO), formed on the surface of glass or other substrate materials. Examples of materials which may serve as suitable alignment surfaces and/or substrates include: Polystyrene (general purpose); Styrene Acrylonitrile (SAN); Acrylonitrile-Butadiene-Styrene (ABS) (Transparent); Styrene Butadiene Block Copolymer; Acrylic; Modified Acrylic; Cellulose Acetate; Cellulose Acetate Butyrate; Cellulose Acetate Propionate; Nylon (Transparent); Thermoplastic Polyester (PETG); Polycarbonate; Polysulfone; Inonmer; Polyvinyl Chloride (PVC) Flexible; Polyvinyl Chloride (PVC) Rigid; Ethylene Vinyl Acetate (EVA); Urethane Elastomer, Thermoplastic (TPU); Polyallomer; Polymethylpentene; and Polyimide. Rubbing materials included 1200 MP emory cloth (FIG. 10) and paper towels (FIG. 11). After rubbing, the slides were viewed under a polarizing microscope at approximately 40×. The tests were conducted at a room temperature of 18-20 degrees C.

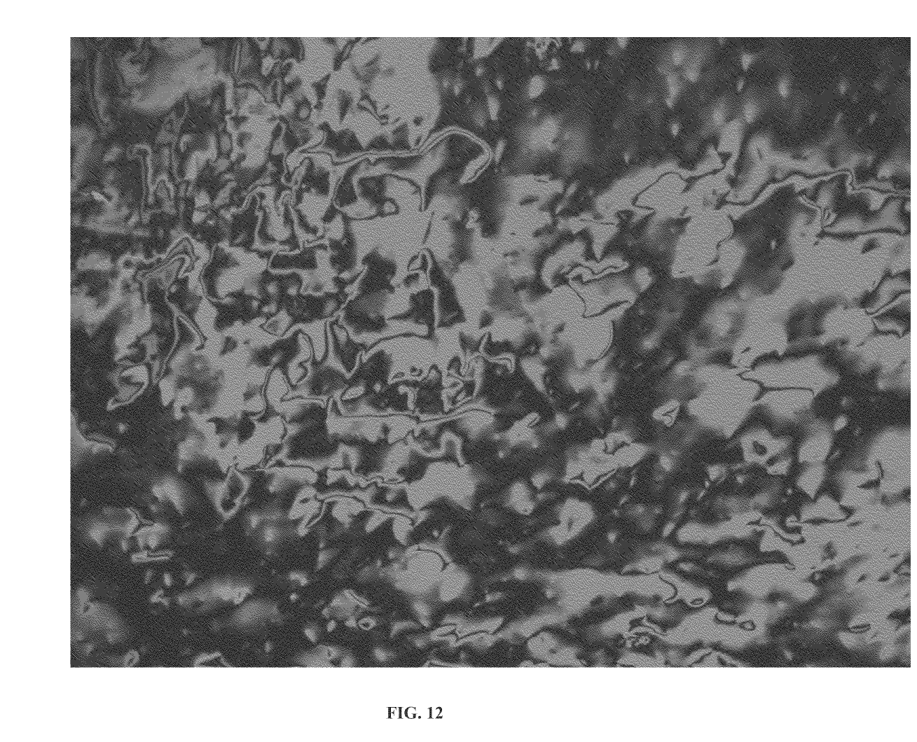

Following rubbing, the slides were placed on a heating block at approximately 40 degrees C. until warm, whereupon approximately 40 uL of 12% sodium chromolyn liquid crystal was deposited on the each slide. A second rubbed slide was then placed on top of the liquid crystal layer with the rub direction of some of the top slides being parallel with the rub direction of the bottom slides and some being anti-parallel, thereby forming slide sandwiches having the liquid crystal in between, which simulate a liquid crystal cell. The sandwiches were then photographed under a microscope using a Regita 2000R monochrome camera. The alignment images are presented in the accompanying figures, with FIG. 12 showing an unrubbed slide revealing no liquid crystal alignment.

It can be appreciated from viewing the accompanying photographic images of glass substrate material rubbed with various rubbing media that liquid crystal alignment was attained quickly, directly on the uncoated substrate substrate surface, thereby eliminating the need for the time-consuming deposition of a costly and precise layer of polymer on the substrate surface.

Changes may be made to the above methods, systems, devices and formulations without departing from the scope hereof. It should be noted that the matter contained in the above description and/or shown in the accompanying drawings should be interpreted as illustrative and not in a limiting sense. The following claims are intended to cover all generic and specific features described herein as well as statements of the scope of the present invention, which, as a matter of language, might be aid to fall therebetween.

What is claimed is:

1. A method for aligning liquid salt-based and lyotropic liquid crystals suspended in a carrier medium contained between two alignment surfaces forming a cell, comprising:
optimizing the concentration of the liquid crystal in the carrier medium;
heating the liquid crystal suspension to a first preselected temperature T, to transform the liquid crystal into its isotropic phase;
heating the cell to a second temperature T₂ which is slightly lower than temperature T, to pre-wet the alignment surfaces during the cell filling process;
filling the cell with the liquid crystal suspension;
rapidly cooling the cell to a third preselected temperature T₃ well into the liquid crystal nematic phase whereby the viscosity of the liquid crystal is substantially increased to prevent the formation of micelles; and
rewarming the cell to a fourth preselected temperature T₄ which lies approximately at the phase line separating the liquid crystal nematic phase from the mixed nematic-isotropic phase.

2. The method of claim 1 wherein the optimized concentration of liquid crystal in the carrier medium is in the range of approximately 9% to approximately 14%.

3. The method of claim 1 wherein the optimized concentration of liquid crystal in the carrier medium is in the range of approximately 10.5% to approximately 12%.

4. The method of claim 1 wherein the liquid crystal is sodium cromolyn.

5. The method of claim 1 wherein the first preselected temperature T, is in the range of approximately 35° C. to approximately 42.5° C.

6. The method of claim 1 wherein the first preselected temperature T is approximately 40° C.

7. The method of claim 1 wherein the second preselected temperature T₂ is in the range of approximately 25° C. to approximately 35° C.

8. The method of claim 7 wherein the second preselected temperature T₂ is approximately 30° C.

9. The method of claim 1 wherein the third preselected temperature T₃ is in the range of approximately 15.5° C. to approximately 16.2° C.

10. The method of claim 9 wherein the third preselected temperature T₃ is approximately 15.8° C.

11. The method of claim 1 wherein the fourth preselected temperature T₄ is in the range of approximately 16.25° C. to approximately 17° C.

12. The method of claim 11 wherein the fourth preselected temperature T₄ is approximately 16.6° C.

13. The method of claim 1 wherein the carrier medium is water.

14. The method if claim 1 further including rubbing each of the two alignment surfaces forming the cell to produce a rubbed surface having features that drive uniform alignment of liquid crystals when the liquid crystals contact the rubbed surface.

15. The method of claim 14 wherein the alignment surfaces are uncoated.

16. The method of claim 14 wherein the alignment surfaces are glass.

17. The method of claim 14 wherein the alignment surfaces are plastic.

18. The method of claim 17 wherein the alignment surfaces are plastics from the group consisting of Polystyrene (general purpose); Styrene Acrylonitrile (SAN); Acrylonitrile-Butadiene-Styrene (ABS) (Transparent); Styrene Butadiene Block Copolymer; Acrylic; Modified Acrylic; Cellulose Acetate; Cellulose Acetate Butyrate; Cellulose Acetate Propionate; Nylon (Transparent); Thermoplastic Polyester (PETG); Polycarbonate; Polysulfone; Inonmer; Polyvinyl Chloride (PVC) Flexible; Polyvinyl Chloride (PVC) Rigid; Ethylene Vinyl Acetate (EVA); Urethane Elastomer, Thermoplastic (TPU); Polyallomer; Polymethylpentene; and Polyimide.

19. The method of claim 14 wherein the alignment surfaces are thin-film metallized coatings.

20. The method of claim 19 wherein the thin-film metallized coatings are from the group consisting of gold and indium tin oxide (ITO).

21. A rubbed substrate structure for us in a liquid crystal cell comprising:
at least two uncoated alignment surfaces wherein each of the uncoated alignment surfaces wherein each of the uncoated alignment surfaces is rubbed to produce features thereon that drive uniform alignment of liquid crystals when the liquid crystals contact the rubbed surface.
